(19) United States
(12) Patent Application Publication
(10) Pub. No.: US 2008/0065304 A1
(43) Pub. Date: Mar. 13, 2008

(54) Motor vehicle

(75) Inventors: Klaus Bastian, Neuhausen (DE); Adam Kobielski, Bietigheim-Bissingen (DE); Dominik Bender, Stuttgart (DE); Alexander Bogner, Ditzingen (DE); Markus Hofbauer, Rechberghausen (DE); Markus Gantikow, Koenigsbach-Stein (DE)

Correspondence Address: LERNER GREENBERG STEMER LLP, P O BOX 2480, HOLLYWOOD, FL, 33022-2480, US

(73) Assignee: Dr. Ing. h.c. F. Porsche Aktiengesellschaft

(21) Appl. No.: 11/825,799

(22) Filed: Jul. 9, 2007

(30) Foreign Application Priority Data
Jul. 8, 2006 (DE) 10 2006 031 666.5

(51) Int. Cl. G06F 7/00

(52) U.S. Cl. 701/69; 180/197; 180/233; 180/338

(57) ABSTRACT

A motor vehicle, in particular a passenger motor vehicle, has a drive train which has a drive assembly, at least one gear mechanism and a plurality of drive axles. The drive train has at least one transverse lock for locking a rotational speed equalization between wheels of one drive axle and at least one longitudinal lock for locking a rotational speed equalization between two drive axles. A torque distribution of the drive train, namely a torque distribution between the drive axles of the drive train and/or a torque distribution between the wheels of the drive axles, can be determined and visualized for a driver.

### CROSS-REFERENCE TO RELATED APPLICATION

This application claims the priority, under 35 U.S.C. §119, of German application DE 10 2006 031 666.5-51, filed Jul. 8, 2006; the prior application is herewith incorporated by reference in its entirety.

### BACKGROUND OF THE INVENTION

### FIELD OF THE INVENTION

The invention relates to a motor vehicle, in particular a passenger motor vehicle, having at least one drive train which has a drive assembly, at least one gear mechanism and a plurality of drive axles. The drive train has at least one transverse lock for locking a rotational speed equalization between wheels of one drive axle and at least one longitudinal lock for locking a rotational speed equalization between two drive axles.

In all wheel drive passenger motor vehicles known from practice, the drive train of which includes two drive axles which are driven by one or more drive assemblies. A torque which is provided by the drive assembly of the drive train is transmitted to the wheels of the drive axles via at least one gear mechanism of the drive train. Furthermore, the drive train of all wheel drive passenger motor vehicles of this type preferably has two transverse locks and one longitudinal lock, a transverse lock locking a rotational speed equalization between the wheels of one drive axle, and a longitudinal lock locking a rotational speed equalization between two drive axles of the drive train. It is possible with the aid of transverse locks and longitudinal locks of this type to distribute a relatively great torque to the drive axle of the drive train and to the drive wheel of one drive axle with better wheel grip, in order in this way to avoid driven wheels spinning on a smooth or soft roadway. As a result, a variable torque distribution between the drive axles of a drive train and between the wheels of the drive axles is accordingly made possible; however, the current torque distribution in the drive train cannot be recognized by a driver of the motor vehicle.

### SUMMARY OF THE INVENTION

It is accordingly an object of the invention to provide a motor vehicle which overcomes the above-mentioned disadvantages of the prior art devices of this general type, in which a torque distribution of the drive train, namely a torque distribution between the drive axles of the drive train and/or a torque distribution between the wheels of the drive axles, can be determined and visualized for a driver.

With the foregoing and other objects in view there is provided, in accordance with the invention, a motor vehicle, in particular passenger motor vehicles. The motor vehicle contains at least one drive train having a drive assembly, at least one gear mechanism and a plurality of drive axles with wheels. The drive train further has at least one transverse lock for locking a rotational speed equalization between the wheels of one of the drive axles and at least one longitudinal lock for locking a rotational speed equalization between two of the drive axles. A display is provided and receives information from the drive train for determining and visualizing a torque distribution of the drive train. The display visualizes to a driver the torque distribution between the drive axles of the drive train and/or the torque distribution between the wheels of the drive axles.

In the context of the present invention, it is proposed to visualize the torque distribution of the drive train for a driver. As a result, a driver can be shown how the overall torque which is provided by the drive assembly is distributed to the drive axles of the drive train and/or to the wheels of the drive axles.

As a result, a driver can be shown additional information about the driving behavior or driving situation of the motor vehicle.

According to one advantageous development of the invention, the torque distribution can be visualized in the form of a pictogram, in such a way that at least the drive axles of the drive train can be visualized together with the wheels which are assigned to the former and, next to the drive axles, the torque ratio between the torque which is present at the respective drive axle and the overall torque and/or, next to the wheels, the torque ratio between the torque which is present at the respective wheel and the overall torque.

In accordance with an added feature of the invention, the display visualizes at least one determined longitudinal lock value corresponding to a maximum possible proportion of a nominal torque (moment) of a lock which can be routed to one of the drive axles.

In accordance with another feature of the invention, the display visualizes at least one determined transverse lock value corresponding to a maximum possible proportion of a nominal torque (moment) of a lock which can be routed to one of said drive axles.

Other features which are considered as characteristic for the invention are set forth in the appended claims.

Although the invention is illustrated and described herein as embodied in a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a first pictogram for illustrating the invention; and

FIG. 2 is a second pictogram for illustrating a second embodiment of the invention.

### DETAILED DESCRIPTION OF THE INVENTION

The invention relates to a motor vehicle, in particular an all wheel drive passenger motor vehicle. A drive train of an all wheel drive passenger motor vehicle of this type has a plurality of drive axles, namely two, which are driven by a drive assembly. A torque which is provided by the drive assembly is transferred to wheels of the drive axles of the drive train via at least one gear mechanism. A drive train of this type of an all wheel drive passenger motor vehicle preferably has a transverse lock in the region of each drive axle for locking a rotational speed equalization between the wheels of the drive axles. Furthermore, a drive train of this type of an all wheel drive passenger motor vehicle preferably has a longitudinal lock, in order to lock a rotational speed equalization between the drive axles of the drive train.

In the context of the present invention, a motor vehicle is then proposed, in which a torque distribution of the drive train, namely a torque distribution between the drive axles of the drive train and/or a torque distribution between the wheels of the drive axles, can be determined and visualized for a driver.

The torque distribution can be determined or calculated on the basis of variables which are available in an engine control device and/or gear mechanism control device of the motor vehicle. The visualization preferably takes place in what is known as a combined display, in which a very wide variety of motor vehicle data can be visualized, or in a completely self-contained display device.

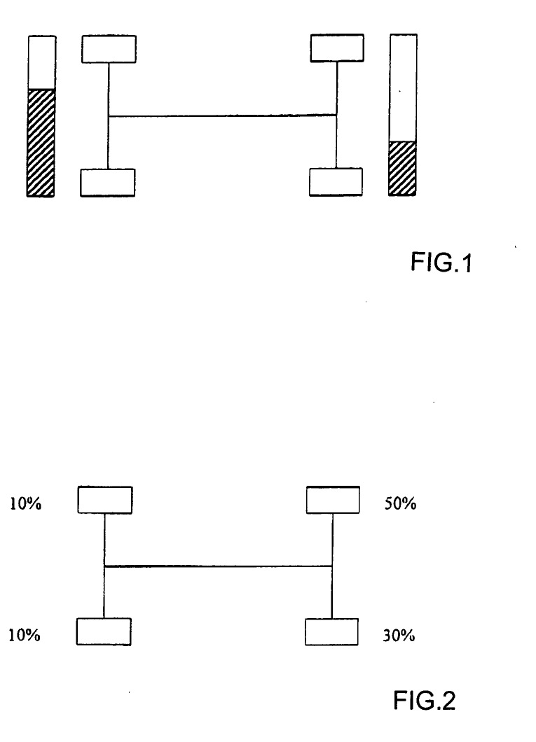

FIG. 1 shows one possible visualization of the torque distribution of a drive train of an all wheel drive passenger motor vehicle, the two drive axles and the wheels of the drive axles of the motor vehicle being shown in FIG. 1 in the form of a pictogram. Next to each drive axle, the torque ratio between the torque which is present at the respective drive axle and the overall torque of the drive train is visualized graphically in the form of a bar, the length of the bars corresponding to the torque ratio, and the sum of the bar lengths corresponding to 100%.

FIG. 2 shows a further possibility for visualizing the torque distribution in a drive train of an all wheel drive passenger motor vehicle, the two drive axles of the drive train and the wheels of the drive axles of the drive train once again also being visualized in FIG. 2 in the context of a pictogram. In FIG. 2, next to each driven wheel of the drive train, a torque ratio is shown between the torque which is present at the respective wheel and the overall torque, namely numerically in the form of a percentage. The sums of all percentages are 100%.

Accordingly, the torque ratio is visualized graphically in FIG. 1 in the form of bars or columns, and the torque ratio is visualized numerically in FIG. 2 in the form of percentages or numbers. It is also possible to combine both displays of FIGS. 1 and 2 with one another.

The visualization of the torque distribution which is shown in FIGS. 1 and 2 is the preferred exemplary embodiment, in which the drive train is shown in the form of a pictogram, and in which torque ratios at the drive axles and/or wheels of the drive train are visualized graphically in the form of bars and/or numerically in the form of percentages.

It is to be noted that it goes without saying that other visualizations of the torque distribution are also possible, for example in the form of pointer instruments, lamps, diodes or other diagrams or graphics.

Furthermore, a longitudinal lock value and a transverse lock value can be determined and visualized, a longitudinal lock value corresponding to a torque difference between two drive axles, and a transverse lock value corresponding to a torque difference between the wheels of one drive axle, in each case in relation to the sum of the respective torques.

1. A motor vehicle, including passenger motor vehicles, comprising:
at least one drive train having a drive assembly, at least one gear mechanism and a plurality of drive axles with wheels, said drive train further having at least one transverse lock for locking a rotational speed equalization between said wheels of one of said drive axles and at least one longitudinal lock for locking a rotational speed equalization between two of said drive axles; and
a display receiving information from said drive train for determining and visualizing a torque distribution of said drive train, said display visualizing to a driver at least one of the torque distribution between said drive axles of said drive train and the torque distribution between said wheels of said drive axles.

2. The motor vehicle according to claim 1, wherein said drive train has two of said drive axles, and at least one of the torque distribution between said two drive axles and the torque distribution between said wheels of said drive axles can be determined and visualized.

3. The motor vehicle according to claim 1, wherein the torque distribution is visualized as a pictogram on said display, said pictogram showing at least said drive axles of said drive train and, next to said drive axles, a torque ratio between a torque present at said respective drive axle and an overall torque.

4. The motor vehicle according to claim 1, wherein the torque distribution is visualized as a pictogram on said display, said pictogram showing at least said drive axles of said drive train together with said wheels assigned to said drive axles and, next to said wheels, a torque ratio between a torque present at said respective wheel and an overall torque.

5. The motor vehicle according to claim 3, wherein said torque ratio is visualized graphically at least as one of bars, columns, numerically as numbers, and numerically as percentages.

6. The motor vehicle according to claim 4, wherein said torque ratio is visualized graphically at least as one of bars, columns, numerically as numbers, and numerically as percentages.

7. The motor vehicle according to claim 1, wherein said display visualizes at least one determined longitudinal lock value corresponding to a maximum possible proportion of a nominal torque of a lock which can be routed to one of said drive axles.

8. The motor vehicle according to claim 1, wherein said display visualizes at least one determined transverse lock value corresponding to a maximum possible proportion of a nominal torque of a lock which can be routed to one of said drive axles.
